(19) United States
(12) Patent Application Publication
(10) Pub. No.: US 2015/0120933 A1
(43) Pub. Date: Apr. 30, 2015

(54) Sharing Network Resources

(71) Applicant: Microsoft Corporation, Redmond, WA (US)

(72) Inventor: Thomas Stuart Yates, Stockholm (SE)

(73) Assignee: Microsoft Corporation, Redmond, WA (US)

(21) Appl. No.: 14/191,000

(22) Filed: Feb. 26, 2014

(30) Foreign Application Priority Data
Oct. 31, 2013 (GB) 1319271.1

(51) Int. Cl. H04L 12/911

(52) U.S. Cl. CPC H04L 47/70
USPC 709/226

(57) ABSTRACT

A network resource allocator comprising: processing means configured to: receive, from each of a plurality of applications connected to a network providing an available network resource, a request for network resource of the available network resource; and for each of the plurality of applications: determine an allocation of the available network resource for use by the application based on said received requests; and transmit, an indication of said allocation to the application for use by said application.

### RELATED APPLICATIONS

This application claims priority under 35 USC §119 or §365 to Great Britain Patent Application No. 1319271.1 entitled “Sharing Network Resources” filed Oct. 31, 2013 by Thomas Stuart Yates, the disclosure of which is incorporate in its entirety.

### BACKGROUND

A wireless access point is a device that allows wireless devices to connect to a wired network using Wi-Fi, or related standards. A wireless access point typically connects to a wired Ethernet connection and the wireless access point provides a wireless local area network (WLAN) which enables other devices to utilize that wired connection via wireless connections using radio frequency links.

Computer or mobile applications performing a plurality of processes often manage the network resources they consume themselves to ensure all competing consumption of network resource (i.e. bandwidth) is shared fairly between the plurality of processes performed by the application to enable the application to perform effectively.

A WLAN is a resource limited environment in that the total network resources of the network are shared between devices connected to the wireless access point. When these computer or mobile applications are placed in a resource limited environment such as a WLAN, these applications need to compete with other independent applications, and the default behaviour of an application is to greedily try to maximize consumption of limited network resources.

### SUMMARY

The inventor has realised that the default behaviour of an application to greedily try to maximize consumption of limited network resources can cause non-optimal performance in the applications when judged as a collective whole.

For example, a voice over internet protocol (VoIP) application communicating with a Wi-Fi access point will try to use as much bandwidth as it can to maximize the quality of a video call. Having many instances of that VoIP application on that same WLAN (i.e. all communicating with the same Wi-Fi access point) will cause sub-optimal call quality in the calls on average due to the instances of the VoIP application competing rather than collaborating on shared network resources, in this case bandwidth.

According to one aspect of the invention there is provided a network resource allocator comprising: processing means configured to: receive, from each of a plurality of applications connected to a network providing an available network resource, a request for network resource of the available network resource; and for each of the plurality of applications: determine an allocation of the available network resource for use by the application based on said received requests; and transmit, an indication of said allocation to the application for use by said application.

According to another aspect of the invention there is provided a method, implemented by an application executed on a device, said device connected to a network providing an available network resource, the method comprising: transmitting, via a network interface of said device, a request for network resource of the available network resource to a network resource allocator; receiving, via said network interface, an indication of an allocation of said available network resource from the network resource allocator; and limiting usage of the available network resource in accordance with said allocation.

According to a further aspect of the invention there is provided a computer program product, the computer program product being embodied on a non-transient computer-readable medium and configured so as when executed on a processor of device comprising a network interface to: receive, via said network interface, from each of a plurality of applications connected to a network providing an available network resource, a request for network resource of the available network resource; and for each of the plurality of applications: determine an allocation of the available network resource for use by the application based on said received requests; and

transmit, via said network interface, an indication of said allocation to the application for use by said application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

For a better understanding of the described embodiments and to show how the same may be put into effect, reference will now be made, by way of example, to the following drawings in which:

FIG. 1 shows a communication system;

FIG. 2 shows a schematic view of a user terminal;

FIG. 3 is a flow chart for a process of an application limiting its usage of available network resource; and

FIG. 4 is a flow chart for a process of a network resource allocator providing allocations of available network resource to network resource consuming applications.

### DETAILED DESCRIPTION

Embodiments will now be described by way of example only.

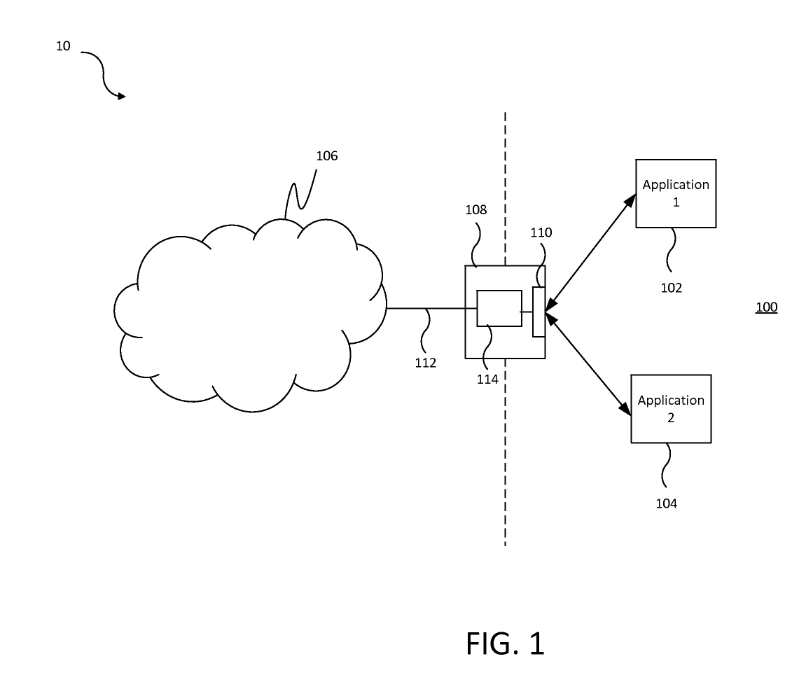

FIG. 1 shows a communication system 10 comprising a first application (application 1) 102 and a second application (application 2) 104 in a network 100 with limited network resources (i.e. a WLAN) and accessing a packet based network 106 i.e. the Internet on a connection 112 via a network controller 108 (i.e. a Wi-Fi access point). FIG. 1 shows only two applications in the network 100 for simplicity but it will be appreciated that any number of applications may use the network resources of the network 100.

The first application 102 and the second application 104 in the network 100 are implemented in software and when executed on a processor of a device connected to the network controller 108 operate to transmit data to, and/or receive data from the network controller 108. The first application 102 and the second application 104 may be executed on the same device or on separate devices. A device may be connected to the network controller 108 via a wired or wireless connection.

The network controller 108 comprises a processing means 114 and a network interface 110 for communication with applications in the network 100. The network controller 108 utilizes a portion of frequency spectrum and provides a total available network resource (i.e. bandwidth) to applications in the network 100.

In data communications, the maximum rate at which information is transmitted over a channel (i.e. the channel capacity often referred to as a connection speed with units of bits per second, bps) is proportional to the available bandwidth. The bandwidth is the amount of frequency spectrum available in the channel, which is measured in Hertz (Hz). For example, the Wi-Fi 802.11g wireless technology uses the 2.4 GHz frequency band which has a frequency band range from 2.401 to 2.495 GHz (i.e. a bandwidth of 0.094 GHz, or 94 MHz). This frequency band range is divided into multiple overlapping channels, each channel having a bandwidth of 22 MHz and supports a theoretical maximum data rate of 54 Mbps. Depending on the wireless technology, different modulation schemes (methods used to place data on the RF signal) are used, such modulation schemes are well known to persons skilled in the art and are therefore not described in detail herein.

It will be appreciated that the rate at which information can be transmitted over the communication system 10 will also be limited by the capabilities of the connection 112 between the network controller 108 and the packet based network 106.

In their operation, the first application 102 and the second application 104 “consume” a portion of the total available bandwidth provided by the network controller 108. An application may be an email client application used to transmit and receive email over the communication system 10, a file sharing application, a web browser allowing a user to upload data (i.e. images, videos or other content) to a data store in the network 106 or download data (i.e. a web page, images, videos or other content) from a data store in the network 106, or a communication client application enabling a user to establish calls and other communications over the communication system 10. It will be appreciated that only a selection of possible types of application are described above for illustration purposes, and the present disclosure is not limited to any of these examples. Many different types of applications which exchange data with the network controller 108 are well known to persons skilled in the art, and are not discussed in more detail herein. The first application 102 may be the same type of application as the second application 104. Alternatively, the first application 102 may be of a different type of application as the second application 104.

To illustrate the concepts of the present disclosure, some embodiments will be described below with reference to an application being a communication client application.

Communication systems comprising a packet switched network enable a user of a device to conduct voice or video calls over the packet switched network. Such communication systems include VoIP systems. These systems are beneficial to the user as they are often of significantly lower cost than conventional fixed line or mobile cellular networks. This may particularly be the case for long-distance communication. To use a VoIP system, the user installs and executes a communication client application (i.e. a software program provided by a software provider) on a local processor on their device. The communication client application sets up the VoIP connections as well as providing other functions such as registration of the user. In addition to voice and video communication, the communication client application may also set up connections for other communication media such as instant messaging (“IM”), SMS messaging, file transfer and voicemail.

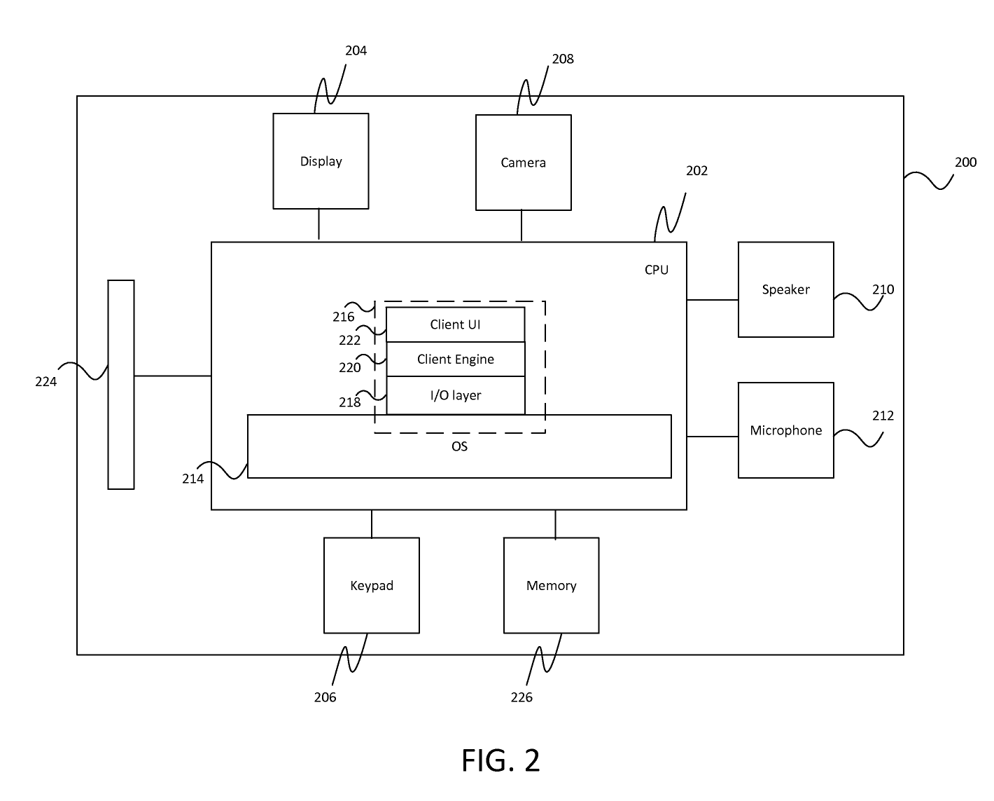

FIG. 2 illustrates a detailed view of the user terminal 200 on which is executed a communication application.

The user terminal 200 may be, for example, a mobile phone, a tablet, a personal digital assistant (“PDA”), a personal computer (“PC”) (including, for example, Windows™, Mac OS™ and Linux™ PCs), a gaming device or other embedded device able to connect to the network 100 via the network controller 108. The user terminal 200 is arranged to receive information from and output information to a user of the user terminal 200.

The user terminal 200 comprises a central processing unit (“CPU”) 202, to which is connected a display 204 such as a screen or touch screen, input devices such as a keypad 206 and a camera 208. An output audio device 210 (e.g. a speaker) and an input audio device 212 (e.g. a microphone) are connected to the CPU 202. The display 204, keypad 206, camera 208, output audio device 210 and input audio device 212 may be integrated into the user terminal 200 as shown in FIG. 2. In alternative user terminals one or more of the display 204, the keypad 206, the camera 208, the output audio device 210 and the input audio device 212 may not be integrated into the user terminal 200 and may be connected to the CPU 202 via respective interfaces. One example of such an interface is a USB interface. The CPU 202 is connected to a network interface 224 for communication with a packet based network. The network interface 224 may be integrated into the user terminal 200 as shown in FIG. 2. In alternative user terminals the network interface 224 is not integrated into the user device 200. The user terminal 200 also comprises a memory 226 for storing data as is known in the art. The memory 226 may be a permanent memory, such as ROM. The memory 226 may alternatively be a temporary memory, such as RAM.

FIG. 2 also illustrates an operating system (“OS”) 214 executed on the CPU 202. Running on top of the OS 214 is a software stack 216 for the communication client application referred to above. The software stack shows an I/O layer 218, a client engine layer 220 and a client user interface layer (“UI”) 222. Each layer is responsible for specific functions. Because each layer usually communicates with two other layers, they are regarded as being arranged in a stack as shown in FIG. 2. The operating system 214 manages the hardware resources of the computer and handles data being transmitted to and from the network 106 via the network interface 224. The I/O layer 218 comprises audio and/or video codecs which receive incoming encoded streams and decodes them for output to speaker 210 and/or display 204 as appropriate, and which receive unencoded audio and/or video data from the microphone 212 and/or camera 208 and encodes them for transmission as streams to other end-user terminals of the communication system 10. The client engine layer 220 handles the connection management functions of the VoIP system as discussed above, such as establishing calls or other connections by server-based or P2P address look-up and authentication. The client engine may also be responsible for other secondary functions not discussed herein. The client engine layer 220 also communicates with the client user interface layer 222. The client engine layer 220 may be arranged to control the client user interface layer 222 to present information to the user of the user terminal 200 via the user interface of the client which is displayed on the display 204 and to receive information from the user the user terminal 200 via the user interface.

The rate at which data can be transmitted over the network 100 to the network controller 108 from an application is limited by the uplink bandwidth available to the application. Similarly, the rate at which data can be transmitted over the network 100 from the network controller 108 to an application is limited by the downlink bandwidth available to the application.

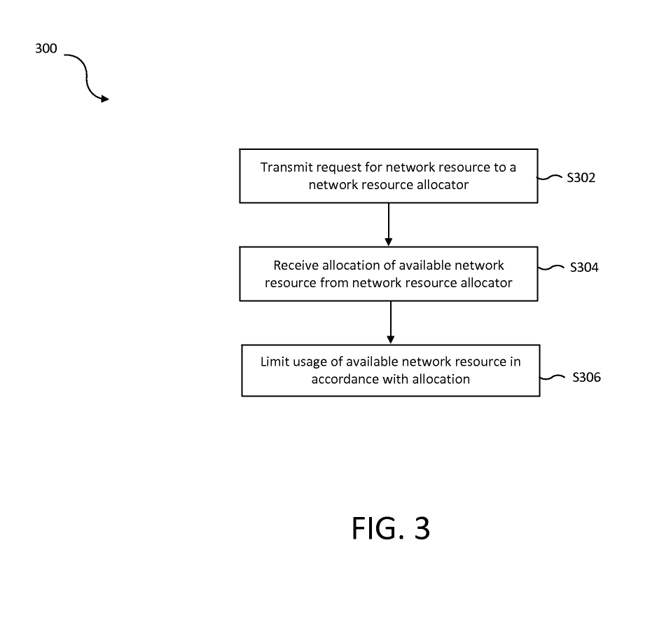

A process 300 of a communication client application (for example the first application 102 or the second application 104) limiting its bandwidth usage of available bandwidth in network 100 will now be described with reference to FIG. 3.

At step S302 the communication client application transmits a request for bandwidth to a network resource allocator in the communication system 10. The request may be for uplink bandwidth (for uploading data to the network controller 108) and/or downlink bandwidth (for downloading data from the network controller 108). The network resource allocator is the entity in the communication system 10 which has an overview of the total available bandwidth in the network 100. The network resource allocator may for example, be the network controller 108.

Step S302 may be implemented by the communication client application merely transmitting an indication that bandwidth is required by the communication client application.

Step S302 may be implemented by the communication client application transmitting, with the indication that bandwidth is required, an indication of the activity which requires the requested bandwidth (for example, a voice call, a video call, a file transfer etc.) to the network resource allocator.

Alternatively, step S302 may be implemented by the communication client application transmitting an indication of a required upload and/or download data rate (i.e. connection speed) to the network resource allocator. The communication client application may be configured with upload and/or download connection speeds required for certain activities, and thus be able to determine a required upload and/or download connection speed based on detecting the activity to be performed. For example that 30 kbps (upload and download) speed is required for voice calls, 128 kbps (upload and download) speed is required for video calls/screen sharing, and 512 kbps (download) and 128 kbps (upload) is required for a group video call with 3 participants. It will be appreciated that these connection speeds are merely examples for illustration purposes only. By transmitting an indication of a required upload and/or download data rate (i.e. connection speed) to the network resource allocator, the communication client application inherently transmits an indication of a required upload and/or download bandwidth to the network resource allocator due to the proportionality between data rate and bandwidth.

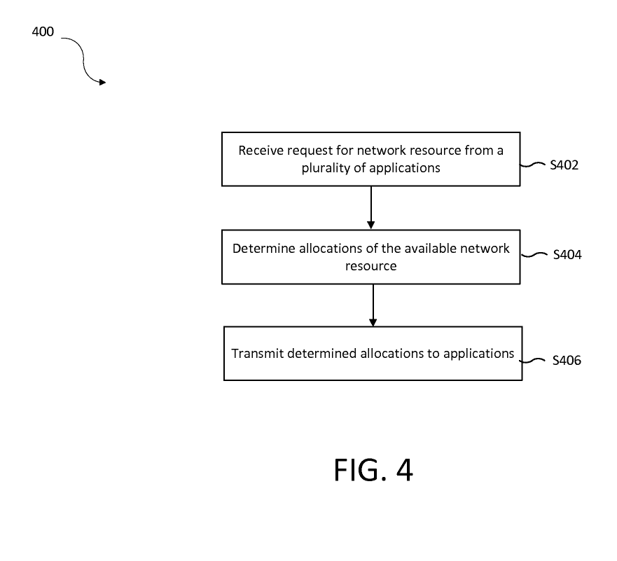

In response to receiving the request for bandwidth that is required by the communication client application, the network resource allocator determines an allocation (i.e. a portion) of bandwidth of the total available bandwidth in the network 100 that is to be used by the communication client application. This process is described in more detail later with reference to FIG. 4.

Referring back to FIG. 3, the process 300 then proceeds to step S304 where the communication client application receives an uplink and/or downlink data rate limit from the network resource allocator. Thus the communication client application receives an allocation of the total available bandwidth that is to be used by the communication client application from the network resource allocator due to the proportionality between data rate and bandwidth.

At step S306, the communication client application applies the limit such that the communication client application limits its bandwidth usage in accordance with the allocation received at step S304. The communication client application limits its bandwidth by controlling the transmission rate at which data is transmitted from, and/or received by the communication client application over a channel between the communication client application and the network controller 108. This may be implemented in a number of ways.

The I/O layer 218 of the communication client application may comprise a plurality of audio codecs for handling the encoding and decoding of audio data. Each of the plurality of audio codecs may be configured to operate at a plurality of different bit rates (and thus require varying amounts of bandwidth). If the communication client application is to handle a communication event during which audio data is to be exchanged (i.e. a voice or video call), step 306 may comprise the communication client application switching to use an alternative audio codec operating at a lower bit rate (and thus use less bandwidth) such that the communication client application complies with its bandwidth allocation. For example, when the request at S302 is for uplink bandwidth (for uploading data to the network controller 108) and the communication client application receives an uplink data rate limit, the communication client application may switch to use an alternative audio codec to encode the data for transmission on the uplink at a lower bit rate so that the uplink data rate limit is not exceeded. Similarly, when the request at S302 is for downlink bandwidth (for downloading data from the network controller 108) and the communication client application receives a downlink data rate limit, the communication client application may switch to use an alternative audio codec to decode the data received on the downlink at a lower bit rate so that the downlink data rate limit is not exceeded. This latter codec switch is reported to the entity in the communication system transmitting the data to the communication client application, so that the entity can switch codec to encode the data for transmission to the communication client application at a lower bit rate.

Similarly, the I/O layer 218 of the communication client application may comprise a plurality of video codecs for handling the encoding and decoding of video data. Each of the plurality of video codecs may be configured to operate at a plurality of different bit rates (and thus require varying amounts of bandwidth). If the communication client application is to handle a communication event during which video data is to be exchanged (i.e. a video call), step 306 may comprise the communication client application switching to use an alternative video codec operating at a lower bit rate (and thus use less bandwidth) such that the communication client application complies with its uplink and/or downlink data rate limit (bandwidth allocation).

The I/O layer 218 of the communication client application may comprise an adaptive bit rate audio codec which can encode/decode audio data at multiple bit rates. If the communication client application is to handle a communication event during which audio data is to be exchanged (i.e. a voice or video call), step 306 may comprise the communication client application controlling the adaptive bit rate audio codec to operate at a lower bit rate (and thus use less bandwidth) such that the communication client application complies with its uplink and/or downlink data rate limit (bandwidth allocation).

Similarly, the I/O layer 218 of the communication client application may comprise an adaptive bit rate video codec which can encode/decode video data at multiple bit rates. If the communication client application is to handle a communication event during which video data is to be exchanged (i.e. video call), step 306 may comprise the communication client application controlling the adaptive bit rate audio codec to operate at a lower bit rate (and thus use less bandwidth) such that the communication client application complies with its uplink and/or downlink data rate limit (bandwidth allocation).

In the case of a video codec, when the request at S302 is for uplink bandwidth (for uploading video data to the network controller 108), the communication client application may control the video codec to skip processing of some frames (reduce frame rate), and/or to downscale images before processing (reduced resolution), and/or adapt its quantization parameters in order to operate at a lower bit rate (and thus use less bandwidth) such that the communication client application complies with its uplink data rate limit (bandwidth allocation). Similarly, when the request at S302 is for downlink bandwidth (for downloading video data from the network controller 108), the communication client application may instruct an entity in the communication system transmitting the video data to skip processing of some frames (reduce frame rate), and/or to downscale images before processing (reduced resolution), and/or adapt its quantization parameters in order to operate at a lower bit rate (and thus use less bandwidth) such that the communication client application complies with its downlink data rate limit (bandwidth allocation).

One or more of the above techniques may be used by the communication client application to limit its bandwidth usage in accordance with the bandwidth allocation received at step S304. Other ways in which the communication client application may limit its bandwidth usage will be apparent to those skilled in the art.

The process 300 may be performed when a communication client application's level of demand for bandwidth changes. This enables the communication client application to request to transmit/receive data at a higher or lower rate (i.e. request more or less bandwidth) from the network resource allocator when its need for bandwidth increases and decreases respectively such that the communication client application receives an allocation of the total available bandwidth proportionate to its need.

A process 400 of a network resource allocator providing a bandwidth allocation of the total available bandwidth in network 100 to each of a plurality of applications will now be described with reference to FIG. 4.

At step S402, the network resource allocator receives a request for bandwidth from each of a plurality of applications executed on one or more devices which have established a connection with the network controller 108. The request for bandwidth from a particular application is described above with reference to step S302 in FIG. 3.

At step S404 for each of the plurality of applications, the network resource allocator determines data rate limits for use by the respective applications (i.e. uplink and/or downlink data rate limits in dependence on the requests received from the respective applications). That is, for each of the plurality of applications, the network resource allocator determines bandwidth allocations of the total available bandwidth provided by the network controller 108 for use by the respective applications based on the requests received at step S402.

The network resource allocator may determine the data rate limits for use by the plurality of applications in a number of ways.

In a simple example, the network resource allocator may determine a data rate limit (and thus a bandwidth allocation) for an application based on the total number of applications which require usage of the total available bandwidth without taking into account the type of activity that the applications will use the bandwidth for. Thus, the total available bandwidth is shared evenly between each of the applications requiring usage of the total available bandwidth. For example, the total available bandwidth may be allocated evenly between two communication client applications (e.g. first application 102 and the second application 104), such that the data rate limit is the same for both the first application 102 and the second application 104. This determination of bandwidth allocation may be used when the request for bandwidth merely indicates that bandwidth is required by the communication client application.

It will be appreciated that in the example described above the first communication client application 102 may require a larger share of the total available bandwidth than the second first communication client application 104 (i.e. may need to transmit and/or receive data at a higher rate) based on the types of activity performed by the communication client applications. For example, the first communication client application 102 may require bandwidth for a video call, whereas the second communication client application 104 may require bandwidth for an IM chat session. In the example described above, the allocated bandwidth is not proportionate to the applications bandwidth requirements.

In other implementations, the network resource allocator may determine the data rate limits (and thus the bandwidth allocations) for each of the plurality of applications based on the applications' level of demand for bandwidth.

For example, when the request for bandwidth received from each of the plurality of applications comprises an indication of the activity to be handled (for example, a voice call, a video call, a file transfer etc.) in addition to an indication that bandwidth is required, the network resource allocator is able to determine using suitable processing logic (i.e. processing means 114 when the network controller 108 performs the function of the network resource allocator) the data rate (and thus the bandwidth to provide the determined data rate) required for the particular activity. The network resource allocator may be configured with upload and/or download rates required for certain activities, and thus be able to determine an appropriate uplink and/or downlink data rate limit (and thus an appropriate upload and/or download bandwidth) based on detecting the activity to be performed by the application. The network resource allocator is able to obtain a global view of the demand for bandwidth from each of a plurality of applications requiring usage of the total available bandwidth and determine a bandwidth allocation for each of the plurality of applications accordingly.

The network resource allocator is also able to obtain the global view of the demand for bandwidth from each of a plurality of applications requiring usage of the total available bandwidth when the request for bandwidth from each application comprises an indication of a required upload and/or download data rate (i.e. connection speed). Thus, the network resource allocator is able to determine a bandwidth allocation for each of the plurality of applications based on the required upload and/or download data rates.

At step S406, the network resource allocator transmits an indication of the determined bandwidth allocations to each of the plurality of applications.

For each of a plurality of applications requesting uplink bandwidth (for uploading data to the network controller 108), at step S406 the network resource allocator transmits an uplink data rate limit. For each of a plurality of applications requesting downlink bandwidth (for downloading data from the network controller 108), at step S406 the network resource allocator transmits a downlink data rate limit.

It will be appreciated from the above that in embodiments of the disclosure the competition for limited network resource is avoided and the performance of the applications is therefore improved.

The network resource allocator is configured to dynamically allocate bandwidth to applications in the network 100 based on the respective applications' level of demand for bandwidth. Having received a bandwidth allocation from the network resource allocator, an application may be able to communicate its bandwidth usage (by indicating the rate at which data has been transmitted from and/or received at the communication client application) to the network resource allocator. If a particular application reports an unused portion of its allocated bandwidth, this allows the network resource allocator to reduce the bandwidth allocation provided to that particular application and re-share the unused portion of bandwidth to the other applications in the network 100. That is, the network resource allocator transmits a new (lower) data rate limit (allocates less bandwidth) to the application that reported an unused portion of allocated bandwidth, and a new (higher) data rate limit (allocates more bandwidth) to each of the other applications in the network 100.

The unused portion of bandwidth may be reallocated equally between the other applications in the network 100 (i.e. the applications using all of their allocated network resource) by the network resource allocator.

Each of the plurality of applications in the network 100 may communicate its application type to the network resource allocator, for example at step S302. The “application type” of an application is defined by the functions that the application is able to perform. One application may be able to perform a plurality of functions.

The reallocation of the unused portion of bandwidth implemented by the network resource allocator may be weighted in dependence on application type information reported from the plurality of applications such that applications of a certain type receive a larger amount of the unused portion than applications of other types. That is, the increase in the data rate limit for applications of a certain type may be larger than the increase in the data rate limit for applications of other types. For example communication client applications may receive a larger amount of the unused portion of bandwidth than email client applications. Alternatively, the unused portion of bandwidth may be reallocated only between applications of a certain type by the network resource allocator. For example, the unused portion of bandwidth may be reallocated only between communication client applications. That is, only communication client applications may receive a new (higher) data rate limit.

Each of the plurality of applications in the network 100 may communicate the service provider associated with the application to the network resource allocator, for example at step S302.

The reallocation of the unused portion of bandwidth may be weighted in dependence on application provider information reported from the plurality of applications such that applications provided by a certain service provider receive a larger amount of the unused portion than applications provided by other service providers. That is, the increase in the data rate limit for applications provided by a certain service provider may be larger than the increase in the data rate limit for applications provided by other service providers. For example communication client applications provided by Skype™ may receive a larger amount of the unused portion of bandwidth than communication client applications not provided by Skype™ Alternatively, the unused portion of bandwidth may be reallocated only between applications provided by a certain service provider by the network resource allocator. For example, the unused portion of bandwidth may be reallocated only between communication client applications provided by Skype™. That is, only communication client applications provided by Skype™ may receive a new (higher) data rate limit.

Various different devices in the communication system 10 may perform the functions of the network resource allocator.

In one embodiment the functions of the network resource allocator is performed by the network controller 108. In this embodiment, requests for bandwidth are received at the network controller 108 using network interface 110. The network controller 108 uses processing means 114 to determine the bandwidth allocations of the total available bandwidth, and the determined bandwidth allocations are communicated to the applications using the network interface 110.

In another embodiment the network resource allocator may for example be at least one node in the network 106 (not shown in FIG. 1). For example the network resource allocator may be a server associated with a service provider (e.g. an operator of the network 106). The service provider may also be a cloud service provider, with the server a “virtual server” (i.e. with the server functionality simulated by software running on one or more computer devices). In this example, the cloud service may have a limited capacity in and out of the service, thus the cloud service will be aware of the total available bandwidth that it can provide (for example based on the capabilities of the connection 112). In this embodiment, each application in the network 100 is configured to transmit an identifier of the network controller 108 that the application is configured to transmit data to, and receive data from, to the node in the network 106. This enables the node in the network 106 to obtain a global view of the demand for bandwidth from each of a plurality of applications requiring usage of the total available bandwidth provided by the connection 112 and a particular network controller 108, and therefore provide the bandwidth allocations of the total available bandwidth to each application in accordance with the process 400 described above with reference to FIG. 4.

In another embodiment, the functions of the network resource allocator may be performed by one of the devices connected to the network 100 on which one or more of the plurality of applications is executed. The local processor on this single device may determine the total available bandwidth provided by the network controller 108 using various methods.

For example the local processor on this single device may use its own estimation of the total available bandwidth provided by the network controller 108, and estimations of the total available bandwidth provided by the network controller 108 received from other devices in the network 100 on which one or more of the plurality of applications is executed, to estimate the total available bandwidth provided by the network controller 108. Techniques for making such an estimation are well known to persons skilled in the art and are therefore not described in detail herein. Alternatively this single device may communicate with the network controller 108 in order to determine the total available bandwidth provided by the network controller 108. Alternatively, a user of the single device may manually configure the local processor with the total available bandwidth provided by the network controller 108 using an appropriate input device.

The local processor on this single device receives requests for bandwidth from one or more applications executed on the local processor. The local processor on this single device also receives requests for bandwidth from one or more applications executed on the other devices connected to the network 100 (received via network interface 224). This enables the device to obtain a global view of the demand for bandwidth from each of a plurality of applications requiring usage of the total available bandwidth provided by the network controller 108, and therefore provide a bandwidth allocation of the total available bandwidth to each application in accordance with the process 400 described above with reference to FIG. 4.

The steps shown separately in FIGS. 3 and 4 may or may not be implemented as separate steps.

Generally, any of the functions described herein can be implemented using software, firmware, hardware (e.g., fixed logic circuitry), or a combination of these implementations. The terms “functionality,” “application”, “service” and “logic” as used herein generally represent software, firmware, hardware, or a combination thereof In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user terminals may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims

1. A network resource allocator comprising:
processing means configured to:
receive, from each of a plurality of applications connected to a network providing an available network resource, a request for network resource of the available network resource; and for each of the plurality of applications:
determine an allocation of the available network resource for use by the application based on said received requests; and
transmit, an indication of said allocation to the application for use by said application.

2. The network resource allocator of claim 1, wherein said network resource comprises an uplink bandwidth for transmission of data from said application over said network, and said allocation comprises an uplink bandwidth allocation.

3. The network resource allocator of claim 2, wherein the indication of said allocation comprises an uplink data rate limit.

4. The network resource allocator of claim 1, wherein said network resource comprises a downlink bandwidth for reception of data at said application over said network, and said allocation comprises a downlink bandwidth allocation.

5. The network resource allocator of claim 4, wherein the indication of said allocation comprises a downlink data rate limit.

6. The network resource allocator of claim 1, wherein the allocation of the available network resource is the same for all of the plurality of applications.

7. The network resource allocator of claim 1, wherein said request comprises an indication of the activity to be performed by said application, and the processing means is configured to allocate the available network resource between said applications based on the activities which are to be performed by the plurality of applications.

8. The network resource allocator of claim 1, wherein said request comprises an indication of a required rate at which data is to be transferred over said network, and the processing means is configured to allocate the available network resource between said applications based on the required rates.

9. The network resource allocator of claim 1, wherein the processing means is further configured to:
receive from said plurality of applications, information pertaining to a level of usage of their allocated network resource;
determine from said information that a portion of the available network resource allocated to at least one of said plurality of applications is unused; and for each of the plurality of applications:
determine a revised allocation of the available network resource for use by the application based on said determination that at least one of said plurality of applications is underusing their allocated network resource; and
transmit an indication of said revised allocation to the application for use by said application.

10. The network resource allocator of claim 9, wherein the processing means is further configured to reallocate the unused portion of the available network resource between applications using all of their allocated network resource.

11. The network resource allocator of claim 10, wherein the processing means is further configured to reallocate the unused portion equally between the applications using all of their allocated network resource.

12. The network resource allocator of claim 10, wherein the processing means is further configured to weight the reallocation of the unused portion between the applications using all of their allocated network resource in dependence on application type information reported from said plurality of applications.

13. The network resource allocator of claim 10, wherein the processing means is further configured to weight the reallocation of the unused portion between the applications using all of their allocated network resource in dependence on application provider information reported from said plurality of applications.

14. The network resource allocator of claim 1, wherein the network resource allocator is one of:
a network controller of said network providing access to a packet based network, said packet based network coupled to said network;
at least one node in said packet based network; and
a device connected to said network, wherein at least one of said plurality of applications is executed on said processing means;

15. A method, implemented by an application executed on a device, said device connected to a network providing an available network resource, the method comprising:
transmitting, via a network interface of said device, a request for network resource of the available network resource to a network resource allocator;
receiving, via said network interface, an indication of an allocation of said available network resource from the network resource allocator; and
limiting usage of the available network resource in accordance with said allocation.

16. The method of claim 15, wherein said allocation is determined by the network resource allocator based on said request and one or more requests received from at least one other application.

17. The method of claim 15, wherein said network resource is an uplink bandwidth for transmission of data from said application over said network, the indication of said allocation comprises an uplink data rate limit, and said limiting comprises limiting a rate at which data is transmitted from said application over said network in accordance with said uplink data rate limit.

18. The method of claim 15, wherein said network resource is a downlink bandwidth for reception of data, transmitted over said network, at said application, the indication of said allocation comprises a downlink data rate limit, and said limiting comprises limiting a rate at which data is transmitted to said application over said network in accordance with said downlink data rate limit.

19. The method of claim 15, wherein the application is a communication client application

20. A computer program product, the computer program product being embodied on a computer-readable medium and configured so as when executed on a processor of device comprising a network interface to:
receive, via said network interface, from each of a plurality of applications connected to a network providing an available network resource, a request for network resource of the available network resource; and for each of the plurality of applications:
determine an allocation of the available network resource for use by the application based on said received requests; and
transmit, via said network interface, an indication of said allocation to the application for use by said application.
